(19) United States
(12) Patent Application Publication
(10) Pub. No.: US 2008/0196251 A1
(43) Pub. Date: Aug. 21, 2008

(54) Support structure for a flexible razor blade assembly

(75) Inventor: Terence G. Royle, Basingstoke (GB)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Gillette Company

(21) Appl. No.: 11/706,669

(22) Filed: Feb. 15, 2007

(51) Int. Cl. B26B 21/22

(52) U.S. Cl. 30/50; 30/58; 30/84

(57) ABSTRACT

A support structure (3) for a safety razor blade assembly (2) that is capable of flexing along its length to follow convex or concave curvatures includes a subframe (15) and end mounts (17) for attachment to the blade assembly at opposite ends thereof coupled to the subframe by respective suspension arm structures (16) each having two arms (21, 22) interconnected by a first pivotal connection (21) and connected to the subframe by a second pivotal connection (23). A restraining device, such as a pin (26) arranged between the blade assembly and the subframe (15) or a torsion bar connected between the subframe (15) and one of the end mounts (17), may be provided to prevent longitudinal displacement of the blade assembly (2).

### FIELD OF THE INVENTION

This invention is concerned with safety razors, also called wet razors, that are capable of conforming to the shape of a surface being shaved.

There are known wet safety razors that are intended to provide a degree of conformance to skin curvatures. Such a safety razor is disclosed in U.S. Pat. No. 7,024,776 (Wain) and a blade suitable for use therein is disclosed in U.S. Pat. No. 6,804,886 (Wain). In WO 99/04938 (Hawes et al) a flexible support for a substantially rigid shaving cartridge is described and includes a pair of arms extending from a handle and a strut interconnecting the free ends of the arms. Flexible safety razor blade units or cartridges are also know, for example from WO 92/06828 (Oldroyd) and GB 2 119 690 (Motta et al). In our pending British Patent Application No. 0615113.8, filed on 28 Jul. 2006 (internal Dkt. Z-04687), there is proposed a safety razor assembly including one or more elongate flexible blades supported by a structure that is deformable for following concave or convex curvatures, the supporting structure including two suspension members each comprising a multiplicity of elongate support elements interconnected by hinges at lower ends and having sliding cooperation with the blade structure at upper ends.

### SUMMARY OF THE INVENTION

The present invention sets out to provide a simple support structure for a flexible blade assembly that provides effective support and control of the blade assembly whilst allowing the blade assembly to flex in order to follow convex and concave skin curvatures.

Provided in accordance with the invention is a support structure for a razor blade assembly comprising a guard structure, a cap structure and one or more blades, the blade assembly having opposed ends and being flexible between the ends, the support structure comprising a subframe, end mounts on which the opposed ends of the blade assembly are carried, the end mounts being coupled to the subframe by suspension arm structures to allow tilting of the end mounts relative to the subframe to permit concave and convex flexing of the blade assembly, and a stop arrangement for at least limiting longitudinal displacement of the blade assembly relative to the subframe.

The invention also includes a safety razor equipped with a support structure as defined above, and a shaving cartridge incorporating a support structure according to the invention as defined above.

The blade assembly preferably includes a plurality of blades, e.g. 2, 3, 4, 5 or possibly even more blades. Conveniently the blades are of the type described in U.S. Pat. No. 6,804,886 B2 (Wain) the entire disclosure of which is hereby incorporated herein by reference. Another alternative within the scope of the invention is a blade comprising a flexible plate or sheet with a number of through holes, e.g. circular holes which have cutting edges extending at least partially around their peripheries. In the embodiments particularly described hereinbelow, the blade assembly includes several elongate parallel blades carried on a flexible frame structure having end portions that are firmly fastened to the respective end mounts of the support structure. The frame structure may be formed as a moulding of elastromeric material and the blades may be secured onto the frame in any suitable manner, such as by overclips wrapped around the frame structure to capture the ends of the blades, as known per se. Alternatively the frame structure may be provided with an arrangement of seats or clips for holding the blades on the frame structure. The blade clips or seats can comprise slots to receive the blades and can be configured to orientate planar blades in inclined dispositions with their cutting edges uppermost. As another alternative the blades can be fastened, such as by welding to underlying frame elements. The sub-assembly of blades and frame elements can be moulded into or otherwise fixed to a frame structure of an elastomeric material.

The guard structure may be constituted by a leading edge portion of the frame structure. Another possibility is for a separate guard member to be attached to the frame structure, for example a guard member of elastometric material that could be moulded in situ onto the frame structure. Preferably the guard structure is formed in one piece and extends continuously along the forward edge of the blade assembly.

The cap structure can include a skin contacting member, such as a strip containing an agent, e.g. a lubricating agent, for application to the skin during shaving. The skin contacting member may additionally or alternatively constitute a source of other shaving enhancement products known per se. Conveniently the skin contacting member comprises a series of segments, either linked together or entirely separate from each other, disposed along a trailing edge portion of the blade assembly. The segments of the skin contacting member may be moulded in situ onto the frame structure.

With a flexible blade assembly carried on a supporting structure in accordance with the invention forces applied to the blade assembly, in the downward direction generally towards the subframe, in a region medially between the ends of the blade assembly will result in the blade assembly deforming to a concave configuration, the end mounts of the support structure tilting upwardly to guide and control the ends of the blade assembly to ensure a smooth curvature along the length of the blades of the blade assembly. Similarly, relatively high downwardly directed forces applied in the region of at least one end of the blade assembly cause the blade assembly to take up a convex curvature along its length with the end mounts tilting downwardly and again ensuring a smooth curvature along the length of the blade assembly. The stop arrangement of the support structure may be configured to substantially preclude longitudinal displacement of the blade assembly, and hence the blades, relative to the subframe and a razor handle. Thus, the stop arrangement may comprise a restraining device that prevents displacement of the blade assembly of the blades in a lengthwise direction. However, a limited amount of longitudinal displacement may be permitted without creating potential risk to a razor user and can be beneficial in facilitating flexing of the blade assembly to conform to skin contours during shaving. In the latter case the stop arrangement can comprise limit stops, e.g. to restrict the deformation of the suspension arm structures. The resilience of the blade assembly can be relied upon to return the blade assembly to a normal straight configuration when it is relieved of any external forces imparted thereon and causing it to deflect from that straight configuration.

In a convenient construction which facilitates mounting of the blade assembly onto the support structure, the end mounts define platforms to which the blade assembly can be easily attached such as by welding, riveting, gluing or the like.

The suspension arm structures can each include two hingedly interconnected arms coupled between the respective end mount and the subframe. More particularly each suspension arm structure may comprise inner and outer arms with the end mounts being disposed at first ends of the outer arms. A second end of the outer arm can be hingedly connected to the first end of the inner arm so that the two arms generally form a V-shape. The second end of the inner arm can be hingedly connected to the subframe. Thus, the inner and outer arms of each suspension arm structure can be connected together by first pivotal connections therebetween, and the inner arms can be connected to the subframe by second pivotal connections. The first and second pivotal connections can each consist of a pivot joint or a living hinge, and in either case the pivotal connections can incorporate limit stops for limiting the range of deformation of the suspension arm structures, and thereby also the longitudinal displacement of the blade assembly with respect to the subframe. The first ends of the outer arms can be upper ends. The second end of the outer arm can be a lower end. The first end of the inner arm can be a lower end, and the second end of the inner arm can be an upper end.

A restraining device that prevents longitudinal movements of the blade assembly relative to the subframe can be arranged between a medial portion of the blade assembly and the support structure for guiding the medial portion of the blade assembly for movement in a direction towards and away from the subframe. For this purpose the restraining device may comprise an elongate member arranged between the blade assembly and the subframe. The elongate member, for example a pin connected to the underside of the cap structure, can have sliding cooperation with the subframe, such as by being arranged to extend through a guide slot formed in the subframe. In an alternative construction the restraining device comprises a torsion bar. The torsion bar is connected at one end to one of the end mounts of the support structure, and at the other end is coupled to the subframe, conveniently at a pivotal connection between the subframe and the suspension arm structure carrying the other end mount.

The foregoing and other advantageous features of the preferred embodiments of this invention will become apparent from the detailed description which follows, reference being made to the accompanying drawings.

### BRIEF DESCRIPTION OF THE DRAWINGS

FIG. 1 shows in plan view a first embodiment of a safety razor blade unit in accordance with the invention;

FIG. 2 is a rear elevation showing the blade unit of FIG. 1;

FIG. 3 is an underneath plan view of the blade unit shown in FIG. 1;

FIG. 4 is a cross-section taken along the line IV-IV in FIG. 2;

FIG. 5 is an end elevation of the blade unit of FIG. 1;

FIG. 6 is a top plan of a shaving cartridge incorporating a support structure according to the invention;

FIG. 7 is a front elevation showing the shaving cartridge of FIG. 6;

FIG. 8 shows the shaving cartridge of FIG. 7 in an underneath plan view;

FIG. 9 is an isometric view of the shaving cartridge of FIG. 6;

FIG. 10 is an end elevation of the shaving cartridge shown in FIG. 6;

FIG. 11 is a cross-section taken along the line XI-XI of FIG. 10;

FIG. 12 shows the shaving cartridge of FIG. 6 in rear elevation;

FIG. 13 is an isometric view of the support structure of the shaving cartridge of FIG. 6;

FIGS. 14A and 14B are a rear elevation and an isometric view showing the support structure of FIG. 13 in a configuration for supporting the blade assembly in a concavely curved form;

FIGS. 15A and 15B are a rear elevation and an isometric view showing the support structure of FIG. 13 in a configuration for supporting the blade assembly in a convexly curved form;

FIG. 16 is a front elevation showing a unitary component of another embodiment of a support structure in accordance with the invention;

FIG. 17 is an isometric view of the support structure component shown in FIG. 16;

FIG. 18 is a front elevation showing a further embodiment of the invention; and

FIG. 19 is a longitudinal cross-section through the embodiment of FIG. 18.

### DETAILED DESCRIPTION OF PREFERRED EMBODIMENTS

Throughout the drawings and the description which follows the same reference numerals have been used to designate corresponding parts and components in the respective embodiments and unless otherwise indicated the description of any part given with respect to one embodiment will apply equally to corresponding parts of other embodiments designated with the same reference numerals.

The blade assemblies and their support structures illustrated in the drawings are in use mounted on razor handles, either permanently with the intention that the entire razor should be discarded when the sharpness of the blades has reduced to an unsatisfactory level, or replaceably so that a used blade assembly can be replaced with a fresh blade assembly with sharp blades. If desired the blade assembly and its support structure can be pivotably mounted with respect to the handle in a manner well known per se, and the support assembly can be biased to a rest position with respect to the handle by a sprung plunger provided in the handle and arranged to act on a cam face formed on the subframe also in a manner known per se. The attachment of the support structure to the handle, may be direct or through the intermediary of a connecting part. The connection to the handle itself is ancillary to the present invention, for which purpose any suitable connection structure can be employed and will not be described further.

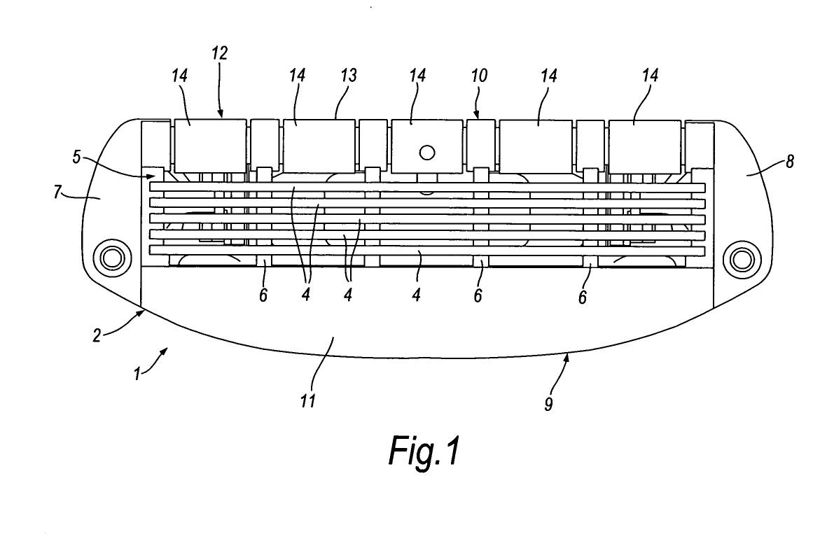

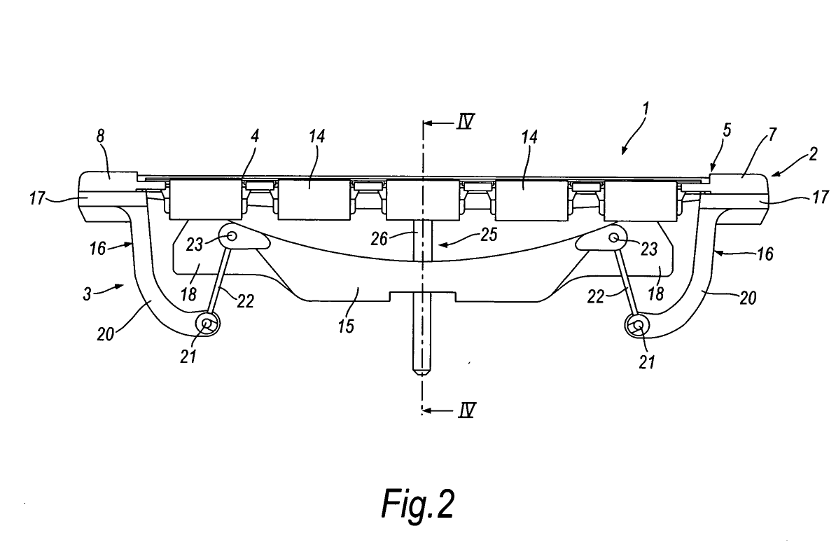

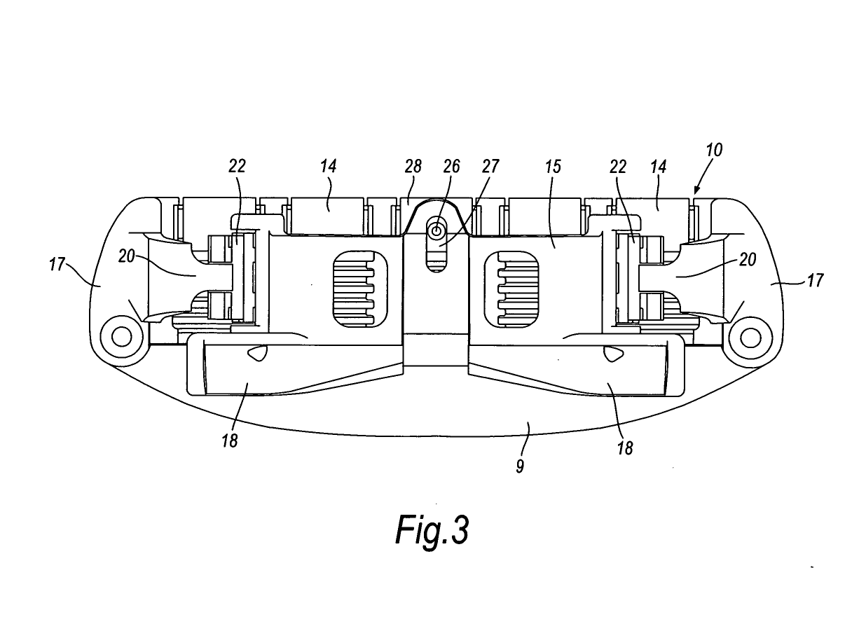

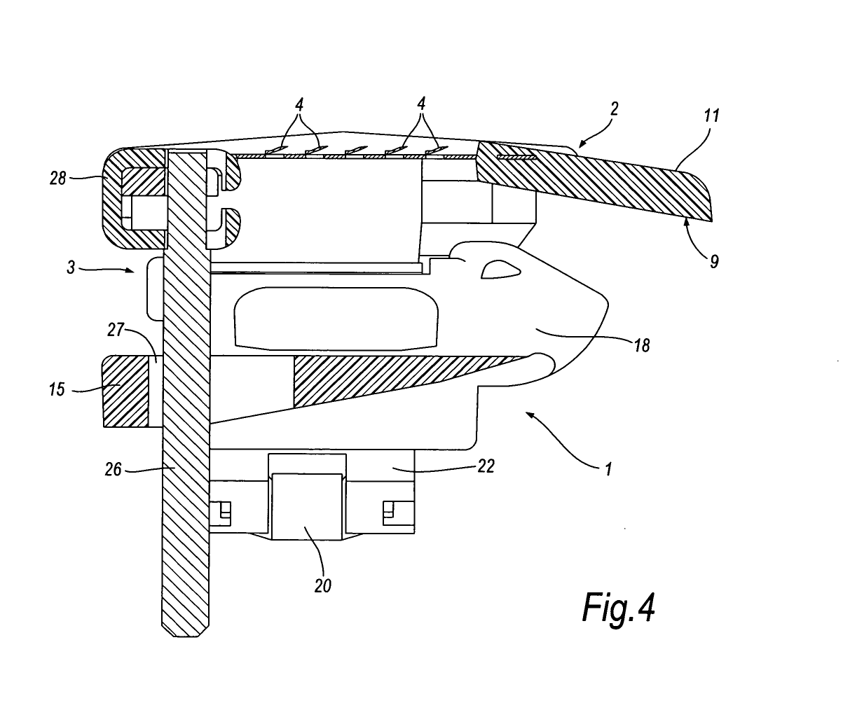

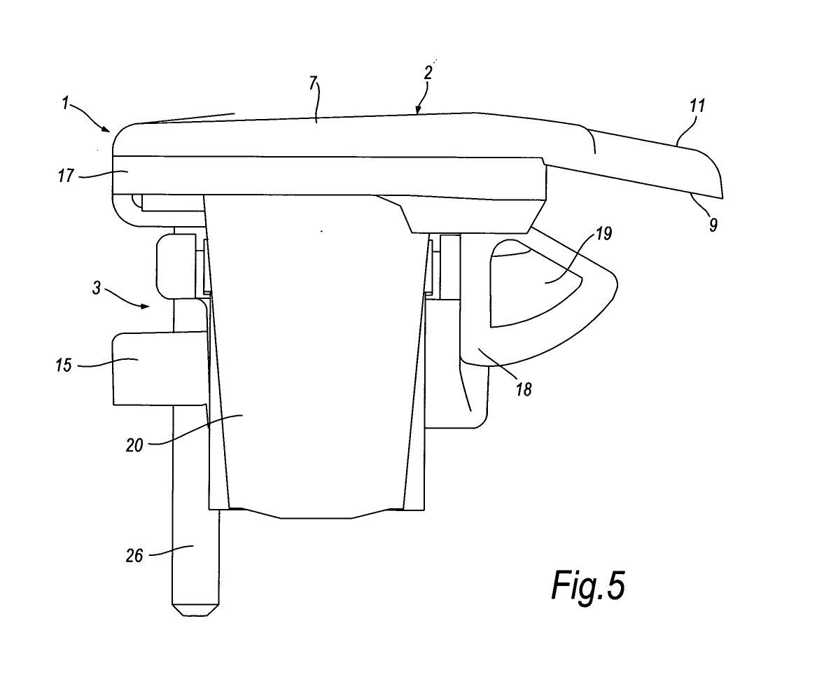

Illustrated in FIGS. 1 to 5 is a blade unit 1 comprising a blade assembly 2 and a support structure 3 for the blade assembly. The blade assembly 2 includes a plurality of elongate blades 4 with parallel forwardly directed cutting edges, there being five blades in the illustrated construction. The blades are flexible along their length and are may be bent blades as described in the above mentioned U.S. Pat. No. 6,804,886 B2 (Wain) the contents of which are incorporated by reference. Alternatively the blades may be planar and can be attached to frame structure in inclined dispositions. The blades 4 are secured to a frame structure 5 of the blade assembly, the frame structure including blade carrier strips 6 which are spaced apart along the blade assembly and to which the blades 4 are fastened, such as by spot welds. The frame structure is flexible along its length from end-to-end and includes end parts 7, 8 interconnected by front and rear members 9 and 10, respectively. The end parts 7, 8 and the front and rear members 9, 10 are conveniently formed as a unitary moulded component of a suitable resiliently flexible material, in particular an elastomeric material. The front frame member 9 constitutes a guard structure 11 of the blade assembly although a separate guard element, such as an elastometric guard could be attached to the frame structure if desired. The rear member 10 may constitute or provide a support for a cap structure 12 which in the illustrated embodiment comprises a lubricating strip 13 attached to the frame as a series of discreet lubricating strip segments 14. By virtue of the flexible blades 4 and the flexible frame structure 5, the blade assembly as a whole is capable of flexing along the length of the blade assembly so that the upper face of the blade assembly where the blades are located can assume a convex or concave curvature.

The blade assembly 2 is mounted on the support structure 3 which has a substantially rigid subframe 15 disposed beneath the blade assembly, and respective suspension arm structures 16 connecting end mounts 17 for the blade assembly to the ends of the subframe. In the exemplary embodiments illustrated in the drawings the end mounts 17 define support platforms for the end parts 7, 8 of the frame structure. The end parts 7, 8 of the frame structure of the blade assembly are fixedly attached to the respective end mounts 17 so that the end parts 7, 8 and the end mounts are constrained to move together during flexing of the blade assembly. Each suspension arm structure 16 includes an outer arm 20 to a first, or upper end as shown, of which the end mount 17 is fixed, and a lower second end of which is hinged by a first pivotal connection 21 to a lower first end of an inner arm 22, shown formed by a plate-like strut, and having its upper second end coupled to the subframe 15 by a second pivotal connection 23, the axes of the first and second pivotal connections 21, 23 being parallel. The suspension arm structures 16 support and guide the end mounts 17 for tilting by performing, for example, swinging movements along arcuate paths i.e. a curvilinear motion, to permit concave and convex flexing of the blade assembly. A stop arrangement is provided to limit or prevent longitudinal displacement of the blade assembly 2 with respect to the subframe 15, and relative to a razor handle (not shown) coupled in use to the subframe. The stop arrangement in the embodiment of FIGS. 1 to 5 comprises a restraining device formed by an upright pin 26 that extends downwardly from the blade assembly and is slidably guided for axial movement in a through slot 27 formed in the subframe. The pin 26 is shown secured to the cap structure of the blade assembly, at a central position along the blade assembly by a clip 28 wrapped around the cap structure and securely holding the pin. Since the central portion of the blade assembly is restrained from movement in the lengthwise direction of the blade assembly, the blade assembly can merely flex by up and down movements of the central portion relative to the subframe 15, and relative to the opposite ends of the blade assembly. When a downward force is applied at the region of the central portion of the blade assembly, this portion will deflect towards the subframe 15 whilst the ends 7, 8 of the blade assembly 2 will move upwardly, due to the suspension arms 16, whereby the blade assembly will assume a concave configuration. A downwardly applied force acting in the region of at least one end of the blade assembly will result in the blade assembly assuming a convexly curved configuration. The inherent resilience of the blade assembly can be relied upon to return the blade assembly to the substantially straight configuration when all external forces exerted thereon are removed.

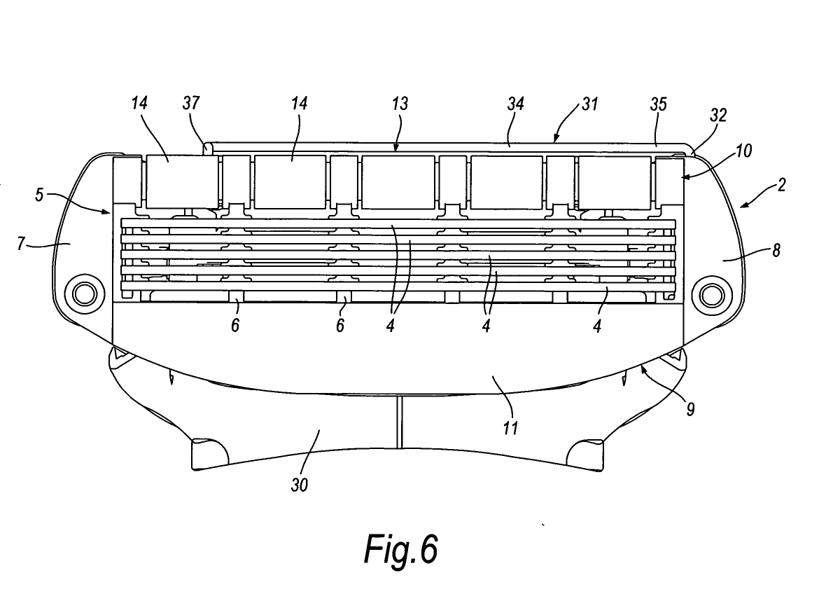

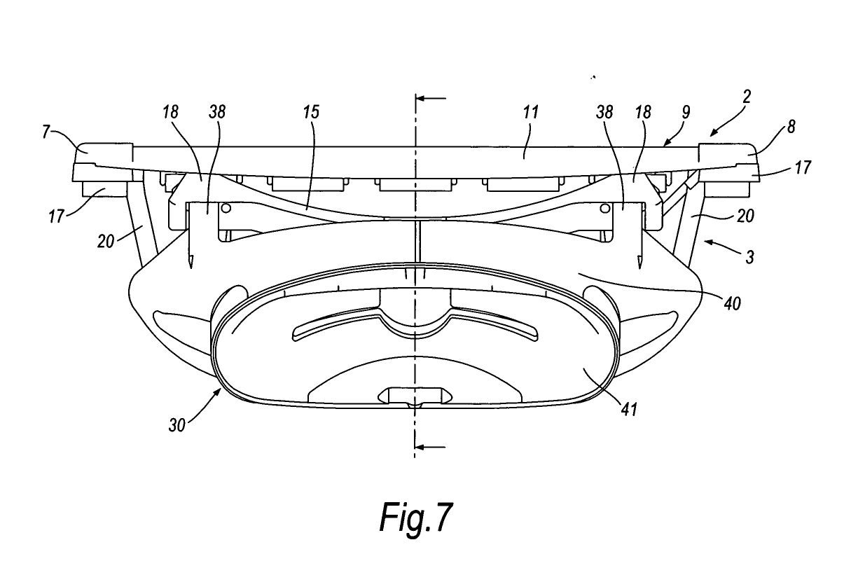

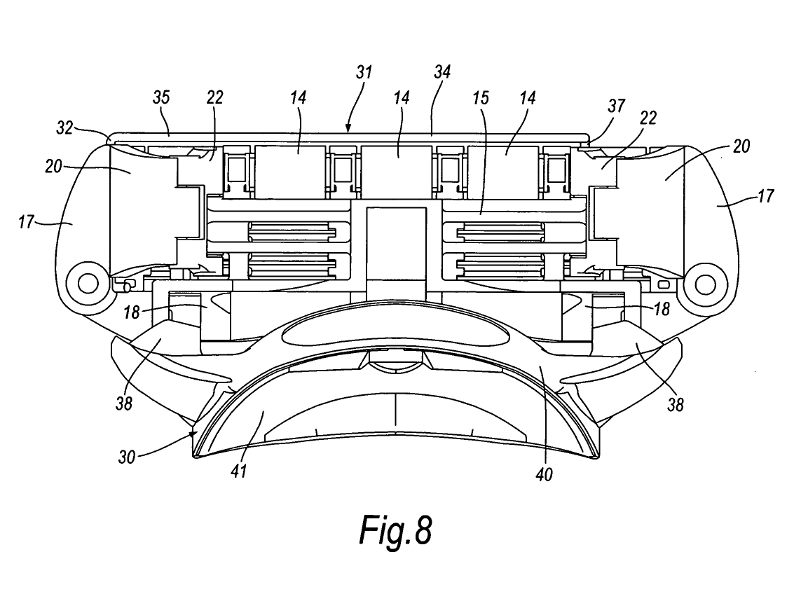

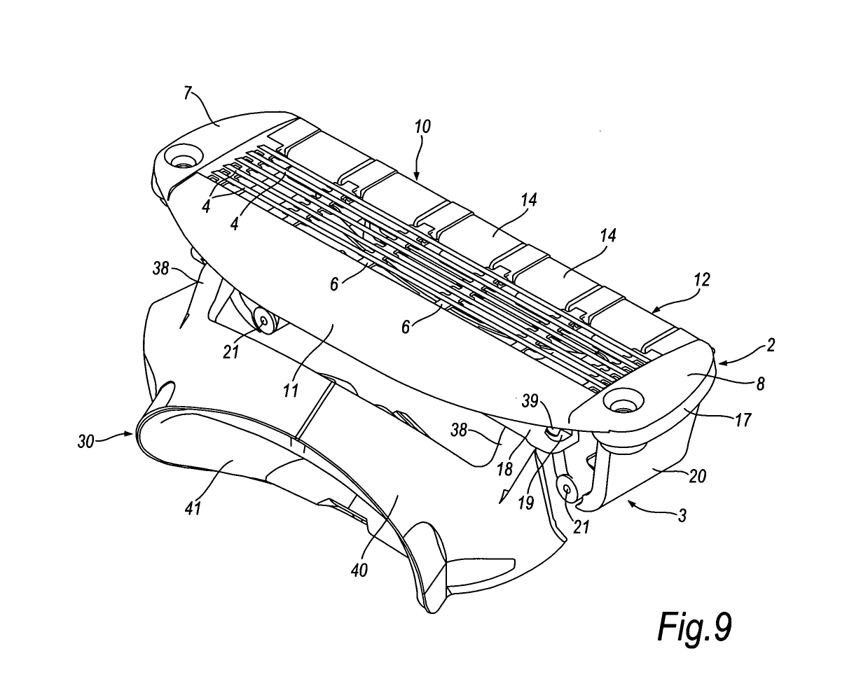

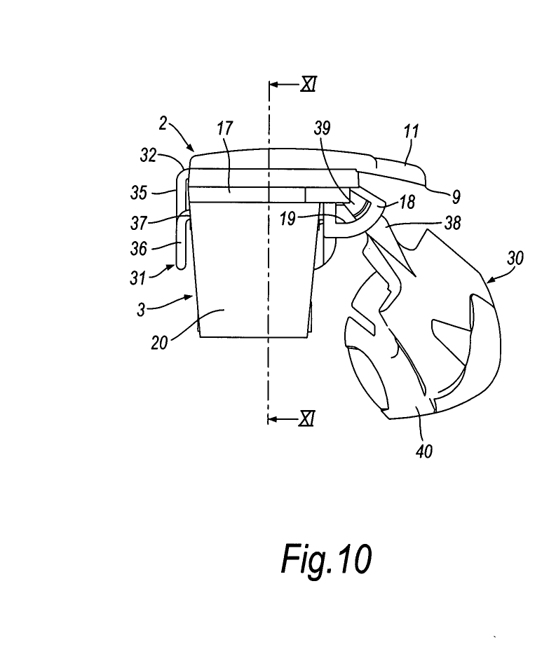

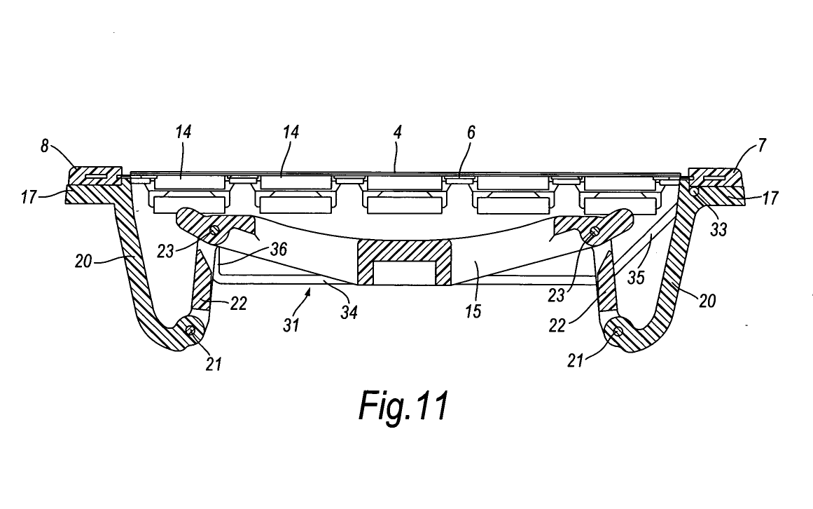

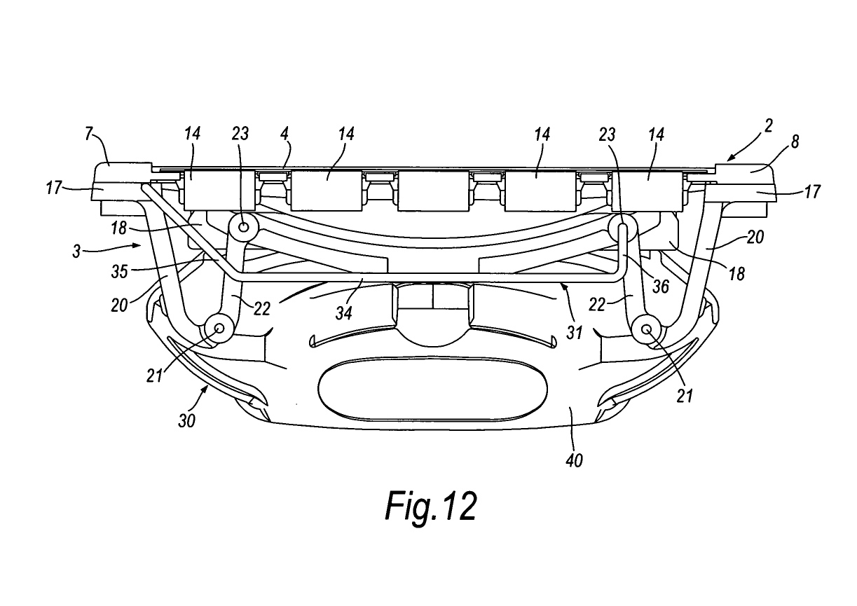

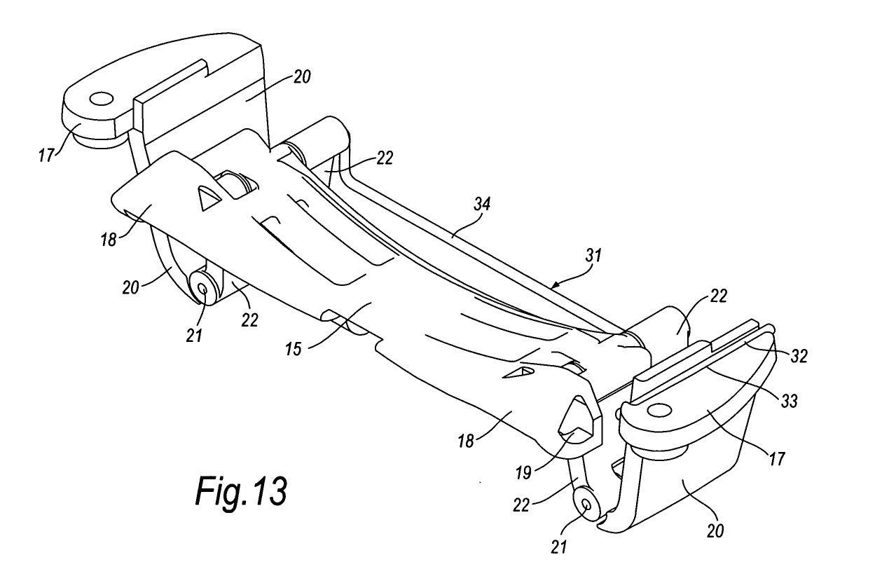

For attaching the blade unit 1 of FIGS. 1 to 5 to a razor handle the subframe 15 is provided with integral attachment points. These attachment points may be arranged for pivotal mounting of the blade unit 1 to enable the blade unit as a whole to pivot about a longitudinal axis extending substantially parallel to the blade edges. The subframe 15 has integral wing members 18 defining journals 19 for pivotal connection of a handle connecting part. The handle connecting part may comprise an interconnect member 30 as employed in the shaving cartridge shown in FIGS. 6-15 and described below.

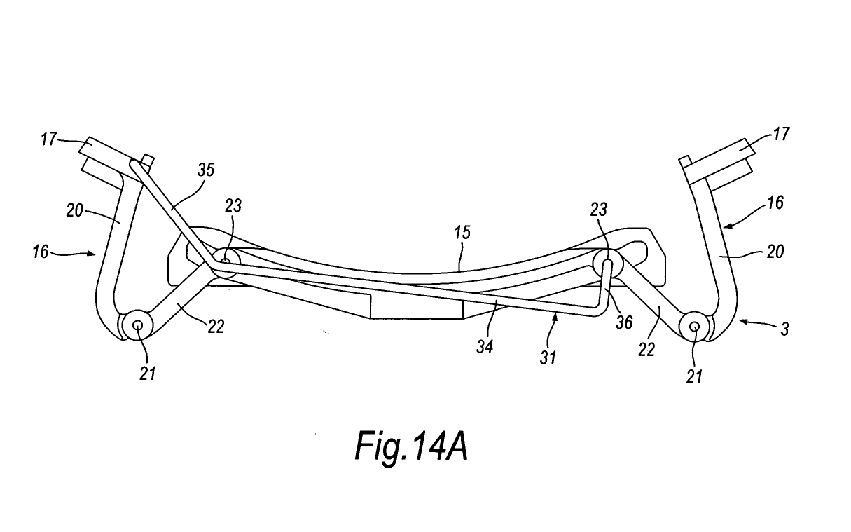

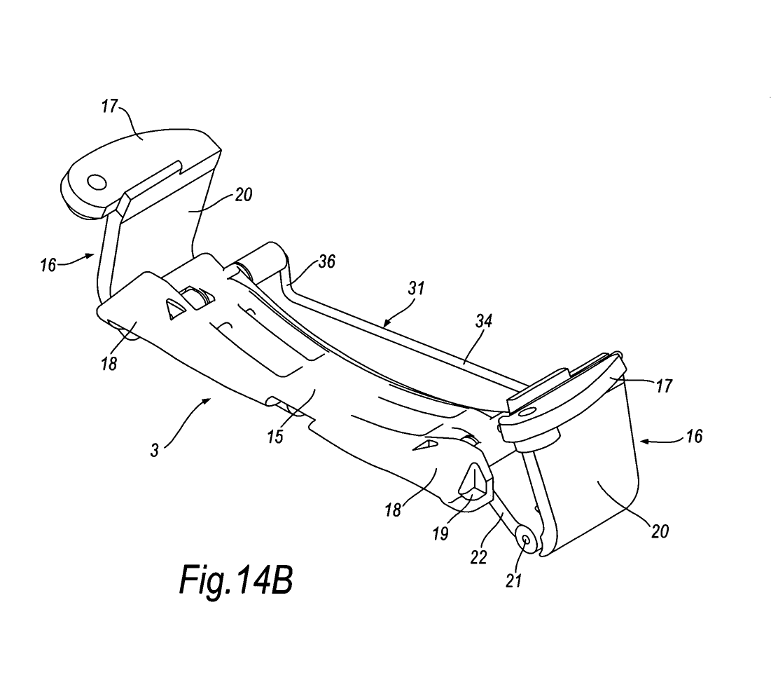

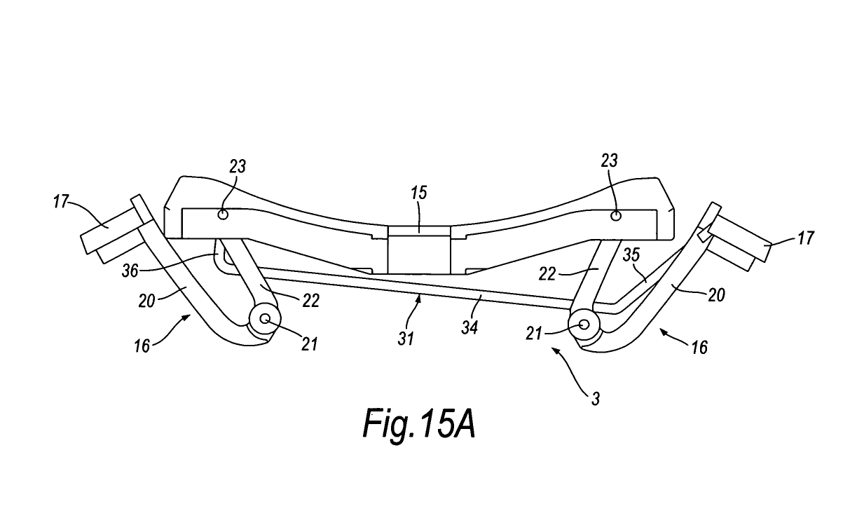

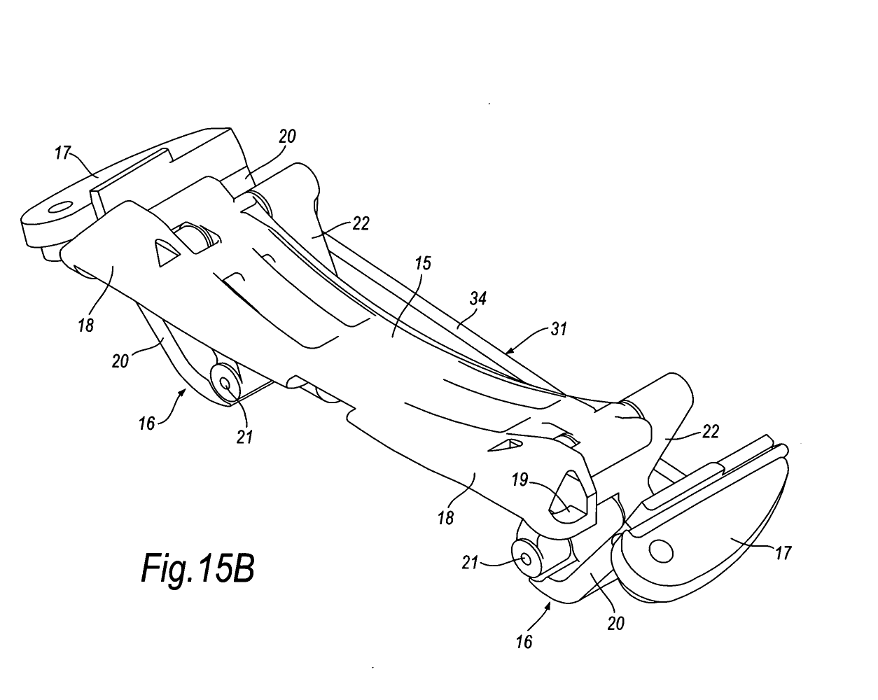

Shown in FIGS. 6 to 15 is a second embodiment of the invention wherein the novel support structure is incorporated in a replaceable shaving cartridge adapted for removable attachment to a razor handle. In addition to a blade unit 1 including a blade assembly 2 and a support structure 3, the cartridge includes an interconnect member 30 for connection to an upper end of a razor handle (not shown). The blade assembly 2 is substantially the same as the blade assembly described above in connection with the first embodiment of FIGS. 1 to 5 and reference should be made to that description for further details of the blade assembly. The support structure 3 of the shaving cartridge is also similar to that of the first embodiment in that it includes a subframe 15, a pair of suspension arm structures 16 carrying respective end mounts 17 and each including an outer arm 20 and an inner arm 22 with hinged connections to the outer arm and the subframe provided by first and second pivot connections 21, 23. The main difference between the support structure of FIGS. 1 to 5 and that of FIGS. 6 to 15 is the form of the restraining device 25 that functions to prevent longitudinal displacement of the blade assembly 2 on the support structure, and instead of a guide arrangement for guiding deflection of a central part of the blade assembly with respect to the subframe, a torsion bar 31 is provided for this purpose. The torsion bar 31 includes a first end portion 32 which is received in a groove 33 provided in the platform surface of one of the end mounts 17, the end portion 32 being rotatable in the groove and being held in the groove by the end part 7 of the blade assembly fixed onto the platform. A main, medial portion 34 of the torsion bar extends in the longitudinal direction generally parallel to the blade assembly, and one end of this medial portion is connected to the first end portion 32 by an inclined torsion bar portion 35 whereas the other end is connected to a short upwardly extending portion 36 substantially perpendicular to the main medial portion 34 and connected at its upper end to a second end portion 37 of the torsion bar which is engaged rotatably with the subframe at the second pivot connection 23. The torsion bar 31 controls the possible movements of the end mount 17 to which it is connected relative to the subframe, and by virtue of the two end mounts being interconnected by the blade assembly 2 the other end mount 17 is constrained to follow those movements in a mirrored fashion, i.e. so that the blade mounts 17 tilt or swing upwardly and downwardly in unison relative to the subframe 15 for the blade assembly 2 to flex into convex and concave curvilinear forms. Thus, FIGS. 14A and 14B illustrate the support structure 16 and end mounts 17 in the tilted positions occupied when the blade assembly (not shown) is deflected into a concave curved shape, e.g. due to a downward force applied at a central region of the blade assembly between the end parts 7, 8, and FIGS. 15A and 15B illustrate the support structure with the suspension arm structures 16 deformed and the end mounts 17 displaced to tilted positions in which the blade assembly is supported in a convexly curved form.

As in the blade unit of FIGS. 1 to 5, the subframe 15 of the support structure in FIGS. 6 to 15 has integral wing members 18 provided with journals 19. The interconnect member 30 has fork arms 38 with protrusions 39 at their free ends engaged in the journals 19, whereby a pivotal connection of the support structure 3 to the interconnect member 30 is obtained, the pivot axis of this pivotal connection extending longitudinally relative to the blade assembly and substantially parallel to the blades 4. The interconnect member has a body 40 with a socket 41 therein for receiving a connecting part provided at the upper end of a razor handle, but any suitable form of connection between the interconnect member and the razor handle can be used.

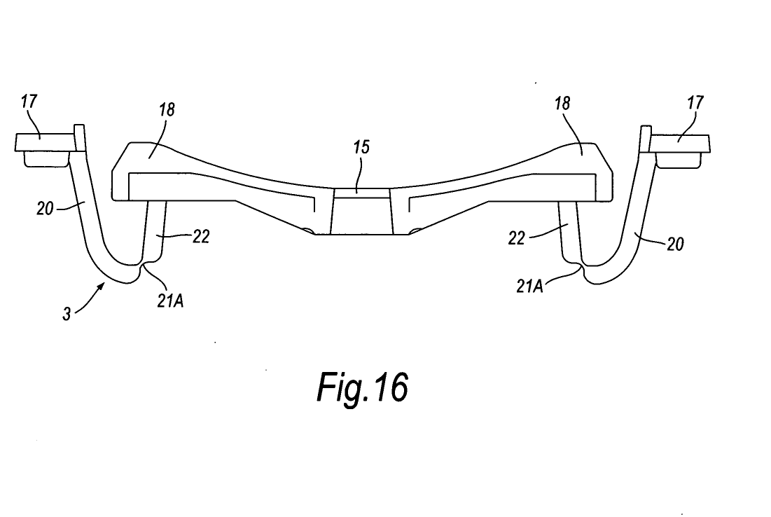

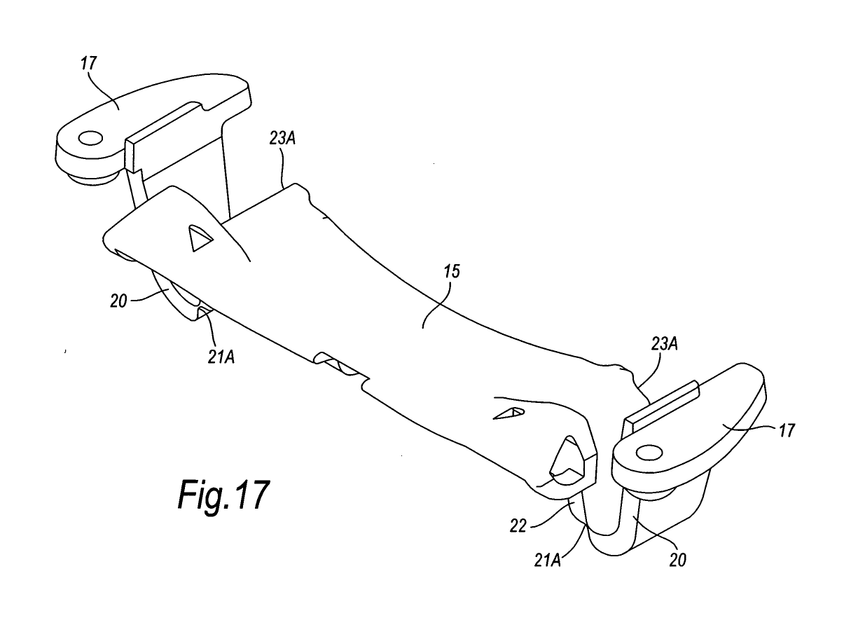

It is not essential for pivot joints to be employed at the connections 21, 23 between the inner arms 22, of the suspension arm structures 16 and the subframe 15, or between the inner arms 22 and the outer arms 20. Shown in FIGS. 16 and 17 is an alternative construction in which the hinged connections are instead provided by living hinge portions 21A, 23A of an integral moulding whereby the subframe 15, the suspension arm structures 16 and the end mounts 17 are formed in one piece as a single moulded part. Other details of the support structure can be as described above in connection with the previous embodiments.

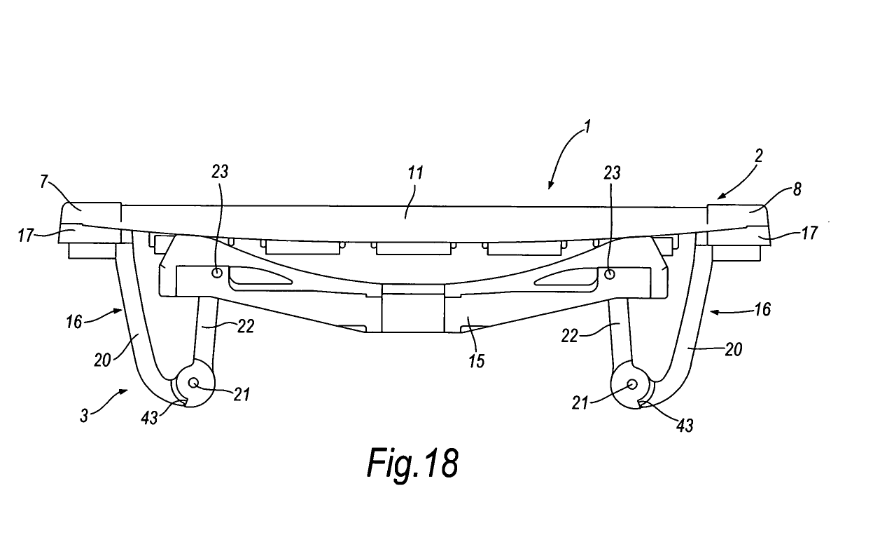

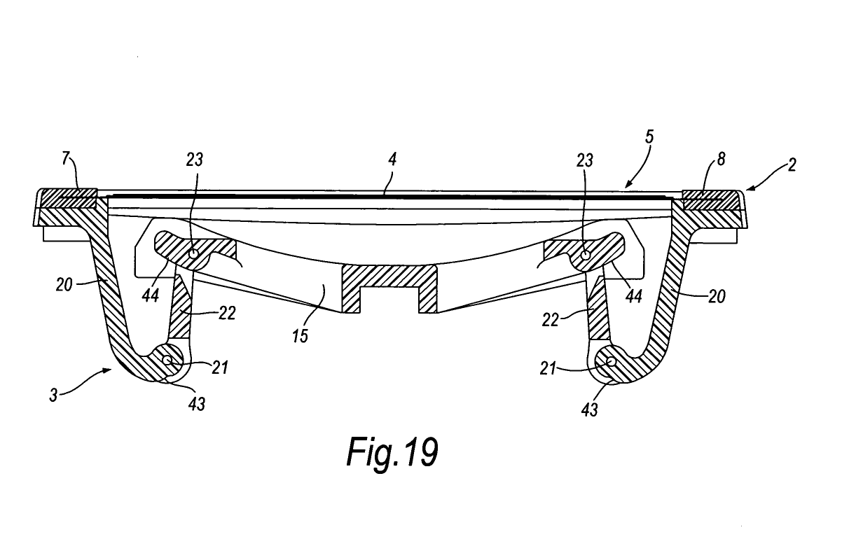

Illustrated in FIGS. 18 and 19 is an embodiment of a support structure according to the invention which is substantially as described above in connection with the embodiments of FIG. 1 to 15 but differs in that a different form of stop arrangement is provided rather than a restraining device for excluding any longitudinal displacement of the blade assembly relative to the subframe, an arrangement of stops to limit such longitudinal displacement of the blade assembly is provided. More particularly stops 43, 44 are provided at the pivotal connections 21, 23 of the inner and outer arms of the suspension arm structures to limit the range of pivotal movements permitted by these pivotal connections. The embodiment shown in FIGS. 16 and 17, wherein living hinge portions 21A, 23A are provided instead of hinge joints, could be provided with similar limit stops, e.g. by appropriate configuration of the living hinges, to restrict the permitted longitudinal displacement of the blade assembly relative to the subframe. A limited range of longitudinal movement of the blade assembly can be beneficial in facilitating flexing of the blade assembly to conform to the skin during shaving.

It should be understood that the foregoing description of the preferred embodiments is given by way of non-limiting example only and that modification and variations are possible without departing from the scope of the invention as defined by the claims which follow. In addition, features described in relation to specific embodiments can be included in other embodiments. Other arrangements for guiding the medial portion of the blade assembly to move towards and away from the subframe besides the pin and slot arrangement of FIGS. 1 to 5 are easily conceivable, for example, and will occur to readers skilled in the art. One such possibility would be an arm linking the underside of the cap structure 12 to the subframe at the pivotal connection of a suspension arm structure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

List of Reference Numerals

| | |
|---|---|
| 1. | blade unit |
| 2. | blade assembly |
| 3. | support structure |
| 4. | blades |
| 5. | frame structure |
| 6. | blade carrier strips |
| 7. | frame structure end part |
| 8. | frame structure end part |
| 9. | front member |
| 10. | rear member |
| 11. | guard structure |
| 12. | cap structure |
| 13. | lubricating strip |
| 14. | lubricating strip segments |
| 15. | subframe |
| 16. | suspension arm structure |
| 17. | end mounts |
| 18. | wing members |
| 19. | journals |
| 20. | outer arm |
| 21. | first pivotal connection |
| 21A. | first living hinge |
| 22. | inner arm |
| 23. | second pivotal connection |
| 23A. | second living hinge |
| 25. | restraining device |
| 26. | pin |
| 27. | through slot |
| 28. | clip |
| 30. | interconnect member |
| 31. | torsion bar |
| 32. | first end portion of torsion bar |
| 33. | groove |
| 34. | medial portion of torsion bar |
| 35. | inclined portion of torsion bar |
| 36. | upwardly extending torsion bar port |
| 37. | second end portion of torsion bar |
| 38. | fork arms |
| 39. | protrusions |
| 40. | body |
| 41. | socket |
| 43. | limit stop |
| 44. | limit stop |

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A support structure for a razor blade assembly (2) comprising a guard structure (12), a cap structure and one or more blades (14), the blade assembly having opposed ends and being flexible between the ends, the support structure (3) comprising a subframe (15), end mounts (17) on which the opposed ends of the blade assembly are carried, the end mounts (17) being coupled to the subframe (15) by suspension arm structures to allow tilting of the end mounts (17) relative to the subframe (15) to permit concave and convex flexing of the blade assembly (2), and a stop arrangement for at least limiting longitudinal displacement of the blade assembly (2) relative to the subframe (15).

2. A support structure according to claim 1, wherein the end mounts (17) define platforms for secure attachment of the blade assembly thereto.

3. A support structure according to claim 1, wherein each of the suspension arm structures (16) includes inner and outer arms (22, 20) and the end mounts (17) are located at first ends of the outer arms (20).

4. A support structure according to claim 3, wherein the outer arm (20) of each suspension arm structure (16) has a second end hingedly connected to a first end of the inner arm (22).

5. A support structure according to claim 4, wherein the inner arm (22) of each suspension arm structure (16) has a second end hingedly connected to the subframe (15).

6. A support structure according to claim 3, wherein the inner and outer arms (22, 20) of the suspension arm structures (16) are interconnected by first pivotal connections (21) therebetween, and the inner arms (20) are connected to the subframe (15) by second pivotal connections (23).

7. A support structure according to claim 6, wherein the stop arrangement for limiting longitudinal movement of the blade assembly (2) relative to the subframe is formed by the pivotal connections (21, 23).

8. A support structure according to claim 6, wherein the pivotal connections comprise living hinges.

9. A support structure according to claim 6, wherein the pivotal connections comprise pivot joints.

10. A support structure according to claim 1, wherein the stop arrangement comprises a restraining device (25) to prevent longitudinal displacement of the blade assembly relative to the subframe.

11. A support structure according to claim 10, wherein the restraining device (25) is arranged between a medial portion of the blade assembly and the subframe.

12. A support structure according to claim 11, wherein the restraining device (25) comprises an elongate member (26) in sliding cooperation with the subframe (15).

13. A support structure according to claim 12, wherein the elongate member (26) is arranged to extend downwardly from the medial portion of the blade assembly and through a guide slot (27) formed in the subframe (15).

14. A support structure according to claim 13, wherein the elongate member is a pin (26) connected to the cap structure of the blade assembly.

15. A support structure according to claim 10, wherein the restraining device (25) comprises a torsion bar (31).

16. A support structure according to claim 15, wherein the torsion bar (31) has a first end portion (32) connected to one of the end mounts (17).

17. A support structure according to claim 15, wherein the torsion bar (31) is coupled to the subframe (15) at a pivotal connection (23) between the subframe (15) and one of the suspension arm structures (16).

18. A support structure according to claim 15, wherein the torsion bar (31) has a first end portion (32) connected to the end mount (17) carried on a first one of the suspension arm structures (16), a longitudinally extending medial portion (34), and a second end portion (37) connected to the subframe (15) at a pivotal connection (23) between the subframe (15) and the second suspension arm structure (16).

19. A support structure according to claim 1, wherein the subframe (15) is provided with attachment points for connection to a razor handle.

20. A support structure according to claim 19, wherein the attachment points comprise journals (19) for pivotal connection of the subframe to a handle connecting structure (30).

21. A shaving cartridge comprising a blade assembly (2) mounted on a support structure (3) as defined in claim 20, and a handle interconnect member (30) with pivot elements engaged with the journals (19) provided on the subframe (15).

22. A razor comprising a handle and a shaving cartridge replaceably attached to the handle, the shaving cartridge being as defined in claim 21.
